(19) United States
(12) Patent Application Publication
(10) Pub. No.: US 2008/0082328 A1
(43) Pub. Date: Apr. 3, 2008

(54) Method for estimating priori SAP based on statistical model

(75) Inventor: Sung Joo Lee, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 11/905,140

(22) Filed: Sep. 27, 2007

(30) Foreign Application Priority Data
Sep. 29, 2006 (KR) 10-2006-0095820

(51) Int. Cl. G10L 19/14

(52) U.S. Cl. 704/234

(57) ABSTRACT

A priori speech absence probability refers to a probability that a speech is not present with respect to a frame and a frequency bin resulting from an input signal. The priori speech absence probability has been regarded as a constant (generally, 0.5) because it is difficult to estimate. However, attempts to estimate the priori speech absence probability have been made since 2002. A novel method for estimating a priori speech absence probability using a statistical model is proposed. The method for estimating a priori speech absence probability obtains a priori speech absence probability of input speech data using a local parameter, a global parameter and an average parameter. The local parameter and the global parameter are obtained by determining a smaller value than a first threshold value as 0, determining a greater value than a second threshold value as 1, and applying a raised cosine function to values between the first threshold value and the second threshold value. The average parameter is obtained by a frame average of a posteriori signal-to-noise ratio in log scale.

### CROSS-REFERENCE TO RELATED APPLICATION

This application claims priority to and the benefit of Korean Patent Application No. 2006-0095820, filed Sep. 29, 2006, the disclosure of which is incorporated herein by reference in its entirety.

### BACKGROUND

1. Field of the Invention

The present invention relates to a method for estimating a priori speech absence probability (SAP) that can be used to improve a speech enhancement system, voice activity detection (VAD) system based on statistical modeling, microphone array processing system and so on.

The present invention has been produced from the work supported by the IT R&D program of MIC (Ministry of Information and Communication)/IITA (Institute for Information Technology Advancement) [2006-S-036-01, Development of large vocabulary/interactive distributed VUI for new growth engine industries] in Korea.

2. Discussion of Related Art

A priori speech absence probability (SAP) refers to a probability that a speech is not present with respect to a frame and a frequency bin resulting from an input signal. The priori speech absence probability has been regarded as a constant (generally, 0.5) because it is difficult to estimate. However, attempts to estimate the priori speech absence probability have been made since 2002.

In order to understand the usage of the estimation of a priori SAP, we will first explain a single channel speech enhancement scheme based on a minimum mean square error (MMSE) using an optimally modified log spectral estimator (OM-LSA). This scheme is described in detail by Israel Cohen, Member IEEE, “Optimal Speech Enhancement Under Signal Presence Uncertainty Using Log-Spectral Amplitude Estimator” IEEE Signal Processing Letters, VOL. 9, NO. 4, April 2002 (“Cohen reference”), which is incorporated by reference herein

Assuming that x(t) denotes a clean speech signal and d(t) denotes an uncorrelated additive random noise signal, an observed noisy signal, y(t) is defined in Equation 1:

y(t)=x(t)+d(t). [Equation 1]

A short-time Fourier transform (STFT) of the observed noisy signal, y(t) is described in Equation 2:

Y(k,l)=X(k,l)+D(k,l), [Equation 2]

where k denotes frequency bin index and l denotes frame index.

It is assumed that H₁(k,l) is a probability that speech is present at l-th frame and k-th frequency bin, and H₀(k,l) is a probability that speech is not present at l-th frame and k-th frequency bin. It is also assumed that the statistical characteristics of speech and noise STFT coefficients follow a complex Gaussian distribution with zero mean and they are statistically independent. When the speech is absent, the conditional probability, p(Y(k,l)|H₀(k,l)) is described in Equation 3:

$$p ( Y ( k , l ) \vert {H}_{0} ( k , l ) ) = \frac{1}{π {λ}_{d} ( k , l )} exp \{ - \frac{{\vert Y ( k , l ) \vert}^{2}}{{λ}_{d} ( k , l )} \} . \qquad [ Equation 3 ]$$

When the speech is present, the conditional probability, p(Y(k,l)|H₁(k,l)) is described in Equation 4:

$$p ( Y ( k , l ) \vert {H}_{1} ( k , l ) ) = \frac{1}{π ( {λ}_{d} ( k , l ) + {λ}_{x} ( k , l ) )} exp \{ - \frac{{\vert Y ( k , l ) \vert}^{2}}{{λ}_{d} ( k , l ) + {λ}_{x} ( k , l )} \} . \qquad [ Equation 4 ]$$

The variance of a clean speech signal is described in Equation 5 and the variance of a noise signal is described in Equation 6:

λₓ(k,l)≡E└|X(k,l)|²|H₁(k,l)┘, and [Equation 5]

λ_{d}(k,l)≡E└|D(k,l)|²┘. [Equation 6]

The conditional speech presence probability, p(k,l)≡P(H₁(k,l)|Y(k,l)) is described in Equation 7:

$$p ( k , l ) = {\{ 1 + \frac{q ( k , l )}{1 - q ( k , l )} ( 1 + ξ ( k , l ) ) exp ( - v ( k , l ) ) \}}^{- 1} \\ q ( k , l ) ≡ P ( {H}_{0} ( k , l ) ) , \\ ξ ( k , l ) ≡ {λ}_{x} ( k , l ) / {λ}_{d} ( k , l ) , \\ γ ( k , l ) ≡ {\vert Y ( k , l ) \vert}^{2} / {λ}_{d} ( k , l ) , \\ and \\ v ( k , l ) ≡ γ ( k , l ) ξ ( k , l ) / ( 1 + ξ ( k , l ) ) . \qquad [ Equation 7 ]$$

In Equation 4, q(k,l)≡P(H₀(k,l)) denotes a priori SAP, ξ(k,l)≡λₓ(k,l)/λ_{d}(k,l) denotes a priori signal-to-noise ratio (SNR), and γ(k,l)≡|Y(k,l)|²/λ_{d}(k,l) denotes a posteriori SNR.

It is important to estimate the conditional speech presence probability p(k,l)≡P(H₁(k,l)|Y(k,l)) since the overall noise reduction performance depends on the conditional speech presence probability. As shown in Equation 7, the conditional speech presence probability p(k,l)≡P(H₁(k,l)|Y(k,l)) can be estimated by a priori and a posteriori SNRs. A priori and a posteriori SNRs can be estimated by a noise, a clean speech and an observed noisy signal variance. An estimator for the conditional speech presence probability is described by Y. Ephraim and D. Malah, “Speech Enhancement using a minimum mean-square error short-time spectral amplitude estimator”, IEEE Trans. Acoust., Speech, Signal Processing, VOL. ASSP-32, pp. 1109-1121, December 1984 (“Ephraim reference”), which is incorporated by reference herein.

A=|X| denotes a spectral amplitude of a clean speech signal. A log spectral amplitude (LSA) estimator is described in Equation 8 by the given statistically independent spectral components:

Â(k,l)=exp{E[log A(k,l)|Y(k,l)]}≡G(k,l)|Y(k,l). [Equation 8]

The conditional probability, E[ log A(k,l)|Y(k,l)] can be obtained in Equation 9.

E[log A(k,l)|Y(k,l)]=E[log A(k,l)|Y(k,l),H₁(k,l)]p(k,l)+E[log A(k,l)|Y(k,l),H₀(k,l)](1−p(k,l)). [Equation 9]

When the speech is absent, the log spectral amplitude (LSA) can be obtained in Equation 10.

exp{E[log A(k,l)|Y(k,l),H₀(k,l)]}≡Gₘᵢₙ|Y(k,l)|. [Equation 10]

When the speech is present, the log spectral amplitude (LSA) can be obtained in Equation 11.

$$exp \{ E [ log A ( k , l ) \vert Y ( k , l ) , {H}_{1} ( k , l ) ] \} ≡ {G}_{H 1} ( k , l ) \vert Y ( k , l ) \vert , \\ where \\ {G}_{{H}_{1}} ( k , l ) = \frac{ξ ( k , l )}{1 + ξ ( k , l )} exp ( \frac{1}{2} {\int }_{v ( k , l )}^{∞} \frac{{e}^{- t}}{t} d t ) . \qquad [ Equation 11 ]$$

By replacing Equation 9 with Equation 10 and 11, the gain function which is derived from an optimally modified log spectral amplitude (OM-LSA) estimator can be described in Equation 12:

$$G ( k , l ) = {\{ {G}_{{H}_{1}} ( k , l ) \}}^{p ( k , l )} {G}_{min}^{1 - p ( k , l )} . \qquad [ Equation 12 ]$$

It is shown in Equation 9 that the gain function is directly affected by the conditional speech presence probability p(k,l)≡P(H₁(k,l)|Y(k,l)). Therefore, an accurate estimation of the conditional speech presence probability is very important for speech enhancement.

Since the priori SAP in Equation 7 essential for the conditional speech presence probability calculation is very difficult to estimate, it has been regarded as a constant (generally, 0.5). Recently, a variety of estimators for a priori SAP have been proposed. Some performance improvements for a speech enhancement system have been shown in Cohen reference mentioned above. It is further described by Min-Seok Choi and Hong-Goo Kang, “An Improved Estimation of A priori SAP For Speech Enhancement: In Perspective of Speech Perception” ICASSP (International Conference on Acoustics, Speech and Signal Processing) 2005 (“Choi reference”), which is also incorporated by reference herein.

The estimator for a priori SAP proposed by Cohen reference uses 3 parameters. A local and global parameter at k-th frequency bin and l-th frame could be obtained by a recursive average of a priori SNR. A frame-index based parameter could be obtained by averaging priori SNR in frequency domain and combining a log function.

In Choi reference, a priori SAP is estimated by a recursive way from parameters that are derived from a posteriori SNR. In this case, a posteriori SNR is obtained recursively at l-th critical band bin. The parameters have a nonlinear characteristics, y=1/(1+x). This may be a reflection of a nonlinear characteristic of a speech presence or absence probability.

However, since the conventional techniques do not positively apply the nonlinear characteristics of the speech presence or absence probability to their SAP estimators, the accuracy of the SAP estimator was limited.

### SUMMARY OF THE INVENTION

The present invention is directed to a method capable of more accurately estimating a priori SAP by adopting the nonlinear characteristics of the priori SAP.

The present invention is also directed to a method for estimating an SAP by adopting a raised cosine function and a sigmoid function.

The present invention is also directed to a method of SAP estimation to improve performance of a speech enhancement scheme using statistical modeling, a voice activity detection scheme or a microphone array scheme.

One aspect of the present invention provides a method for estimating a priori speech absence probability (SAP) of input speech data, the method comprising the steps of: obtaining a local parameter and a global parameter by determining a smaller value than a first threshold value as 0, determining a greater value than a second threshold value as 1, and applying a sigmoid function to values between the first threshold value and the second threshold value; obtaining an average parameter by a frame average of a posteriori signal-to-noise ratio in log scale; and estimating the priori SAP using the local parameter, the global parameter and the average parameter.

As described above, when speech is present in the observed signal, the speech presence probability becomes 1, and when the speech is not present, the speech presence probability becomes 0. That is, the speech presence probability may exhibit a nonlinear characteristic because of its approximate value of 1 or 0. In the present invention, nonlinear characteristic functions such as a raised cosine function and a sigmoid function may be used for more accurate estimation of the priori SAP.

More accurate estimation of a priori SAP contributes to the performance of a speech enhancement system and a voice activity detection system. The present invention proposes a method for estimating a priori SAP in log scale in consideration of the particular characteristics of the human sense of hearing and a probability distribution characteristic of a speech presence probability.

### BRIEF DESCRIPTION OF THE DRAWINGS

The above and other features and advantages of the present invention will become more apparent to those of ordinary skill in the art by describing in detail preferred exemplary embodiments thereof with reference to the attached drawings in which:

FIG. 1 is a block diagram of a typical SAP estimator; and

FIG. 2 is a flowchart illustrating a method for estimating a priori SAP according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the exemplary embodiments disclosed below, but can be implemented in various forms. Therefore, the following exemplary embodiments are described in order for this disclosure to be complete and enabling to those of ordinary skill in the art.

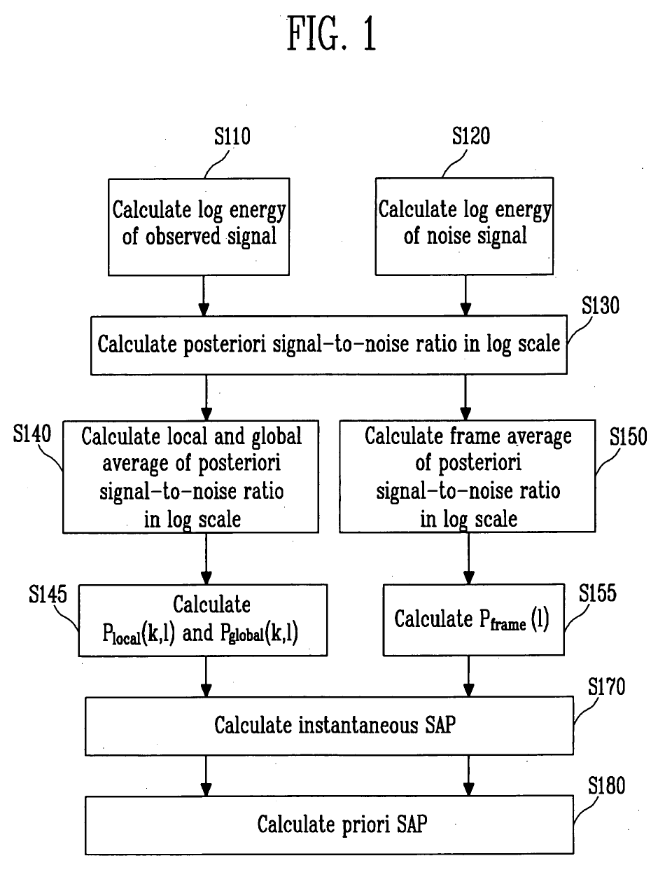

Referring to FIG. 1, a method for estimating a priori SAP according to an exemplary embodiment of the present invention comprises the steps of: obtaining a log energy of an observed signal (S110); obtaining a log energy of a noisy signal (S120); obtaining a posteriori signal-to-noise ratio in log scale by using the log energy of the observed signal and the log energy of the noisy signal (S130); obtaining local and global averages of the posteriori signal-to-noise ratio in log scale from the posteriori signal-to-noise ratio in log scale (S140); obtaining a local parameter and a global parameter by determining a threshold value for the local and global averages and applying a sigmoid function (S145); obtaining a frame average of the posteriori signal-to-noise ratio in log scale (S150); obtaining an average parameter by using the frame average of the posteriori signal-to-noise ratio in log scale (S155); obtaining an instantaneous SAP by using the local parameter, the global parameter and the average parameter (S170); and obtaining the priori SAP by using the instantaneous SAP (S180).

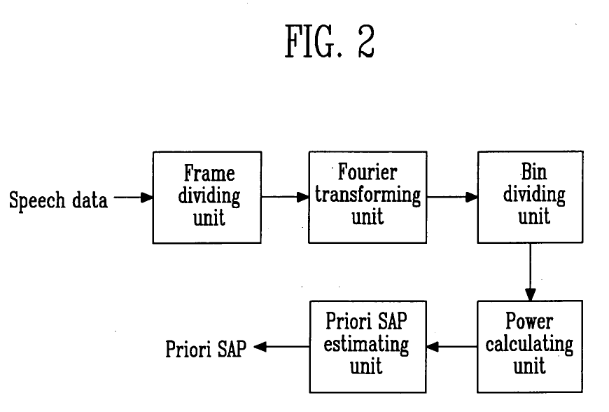

The method for estimating a priori SAP according to the present invention can be performed in a typical speech enhancement system. In the typical speech enhancement system, units for performing the method for estimating a priori SAP are shown in FIG. 2. That is, the method for estimating a priori SAP of FIG. 1 is performed by a priori SAP estimating unit of FIG. 2. Input speech data used for estimating the priori SAP of the present invention is processed by a frame dividing unit, a Fourier transforming unit, a bin dividing unit, and a power calculating unit as shown in FIG. 2, and an observed signal energy y(k,l) and a noisy signal energy d(k,l) for each frame and each bin are obtained. Since a method for obtaining the observed signal energy y(k,l) and the noisy signal energy d(k,l) is well known, a detailed description thereof will be omitted.

A recursive average for an observed signal is obtained in step S110 and described in Equation 13. The log energy of the observed signal is obtained to reflect the particular characteristics of the human sense of hearing that an input signal is converted in log scale.

log_{—}y(k,l)=α log_{—}y(k,l−1)+(1−α)log(|Y(k,l)|²). [Equation 13]

A recursive average for a noisy signal is obtained in step S120 and updated only if speech is not present, and the log energy of the noisy signal may be estimated by a pseudo code scheme as described in Equation 14:

$$if log ( {\vert d ( k , l ) \vert}^{2} ) - log\_d ( k , l - 1 ) \leq SNR\_THRESHOLD \_UPDATE . \\ then \\ if log ( {\vert d ( k , l ) \vert}^{2} ) - log\_d ( k , l - 1 ) \leq 0 , \\ then \\ log\_d ( k , l ) = ( 1 - {β}_{low} ) log ( {\vert d ( k , l ) \vert}^{2} ) \\ if log ( {\vert d ( k , l ) \vert}^{2} ) - log\_d ( k , l - 1 ) > 0 , \\ then \\ log\_d ( k , l ) = ( 1 - {β}_{high} ) log ( {\vert d ( k , l ) \vert}^{2} ) \qquad [ Equation 14 ]$$

In step S180, the priori SAP according to the present invention is obtained by a recursive scheme as described in Equation 15:

q(k,l)=α_{q}q(k,l−1)+(1−α_{q})\tilde{q}(k,l), [Equation 15]

where \tilde{q}(k,l) denotes an instantaneous SAP.

It can be seen from Equation 15 that the instantaneous SAP must be obtained in order to obtain the priori SAP. A method for obtaining the instantaneous SAP will now be described.

In step S170, the instantaneous SAP is obtained by Equation 16. Referring to Equation 16, p(k,l) must be obtained in order to obtain the instantaneous SAP, and three parameters (P_{local}(k,l), P_{global}(k,l), and P_{frame}(l)) must be obtained in order to obtain p(k,l).

$$p ( k , l ) = {P}_{local} ( k , l ) {P}_{global} ( k , l ) {P}_{frame} ( l ) \\ \tilde{q} ( k , l ) = \frac{1}{1 + {e}^{- ɛ ( p ( k , l ) - 0.5 )}} , \qquad [ Equation 16 ]$$

where ε denotes an increasing weight.

In order to obtain a P_{local}(k,l) parameter (a local parameter) and a P_{global}(k,l) parameter (a global parameter), a posteriori signal-to-noise ratio in log scale must be obtained. In step S130, the posteriori signal-to-noise ratio in log scale is obtained by Equation 17:

log_{—}SNR(k,l)=α_{SNR} log_{—}SNR(k,l−1)+(1−α_{SNR})(log_{—}y(k,l)−log_{—}d(k,l)). [Equation 17]

In a frequency domain, a local or global average of the posteriori signal-to-noise ratio in log scale can be obtained by Equation 18 by applying a local or global window to the posteriori signal-to-noise ratio in log scale. (S140).

$${ζ}_{SNR} ( k , l ) = {\sum }_{i = - ω}^{i = {ω}_{λ}} {h}_{SNR} ( i ) log\_SNR ( k - i , l ) . \qquad [ Equation 18 ]$$

Here, a maximum or minimum value of ω may be in linear scale, or in Mel scale in which a sampling number increases with an increasing frequency.

In Equation 18, ζ_{SNR}(k,l) is the average of the posteriori signal-to-noise ratio in log scale. A local average is obtained by applying Equation 18 only to a corresponding bin (i.e., the k-th bin), and a global average is obtained by applying Equation 18 to a predetermined number of bins adjacent to the corresponding bin.

In step S145, using the local or global average of the posteriori signal-to-noise ratio in log scale obtained by Equation 18, a local parameter P_{local}(k,l) and a global parameter P_{global}(k,l) are obtained by Equation 19:

$${P}_{SNR} ( k , l ) = \{ \begin{matrix}0 , if {ζ}_{SNR} ( k , l ) \leq {ζ}_{min} \\ 1 , if {ζ}_{SNR} ( k , l ) \geq {ζ}_{max} \\ \frac{\{ 1 - cos ( π ( \frac{{ζ}_{SNR} ( k , l ) - {ζ}_{min}}{{ζ}_{max} - {ζ}_{min}} ) ) \}}{2} , otherwise .\end{matrix} \qquad [ Equation 19 ]$$

When the local average ζ_{SNR}(k,l) is applied to Equation 19, the local parameter is obtained. when the global average ζ_{SNR}(k,l) is applied to Equation 19, the global parameter is obtained.

In step S150, a frame average of the posteriori signal-to-noise ratio in log scale, ζ_{frame}(l) is obtained by Equation 20:

$${ζ}_{frame} ( l ) = {mean}_{1 \leq k \leq N / 2 + 1} log\_SNR ( k , l ) . \qquad [ Equation 20 ]$$

### In step S155, mean parameter P_{frame}(l) is obtained by Equation 21:

$$\begin{matrix}if {ζ}_{frame} ( l ) > {ζ}_{min} then & [ Equation 21 ] \\ If {ζ}_{frame} ( l ) > {ζ}_{frame} ( l - 1 ) then & \\ {P}_{frame} ( l ) = 1 & \\ {ζ}_{peak} ( l ) = min \{ max [ {ζ}_{frame} ( l ) , {ζ}_{p min} ] , {ζ}_{p min} \} & \\ else & \\ {P}_{frame} ( l ) = μ ( l ) & \\ else & \\ {P}_{frame} ( l ) = 0 & \end{matrix}$$

where μ(l) is described in Equation 22.

$$μ ( l ) = \{ \begin{matrix}0 , & \begin{matrix}if {ζ}_{frame} ( l ) \leq \\ {ζ}_{peak} ( l ) + {ζ}_{min}\end{matrix} \\ 1 , & \begin{matrix}if {ζ}_{frame} ( l ) \geq \\ {ζ}_{peak} ( l ) + {ζ}_{max}\end{matrix} \\ \frac{1 - cos ( π ( \frac{\begin{matrix}{ζ}_{frame} ( l ) - \\ ( {ζ}_{peak} ( l ) + {ζ}_{min} )\end{matrix}}{{ζ}_{max} + {ζ}_{min}} ) )}{2} , & otherwise .\end{matrix} \qquad [ Equation 22 ]$$

As described above, a method for estimating a priori SAP according to the present invention applies the nonlinear characteristics to the priori SAP. Thus, the priori SAP can be more accurately estimated.

Furthermore, the more accurately estimated priori SAP improves the performance of a speech enhancement scheme, a voice activity detection scheme, or a microphone array scheme using priori SAP-based statistical modeling.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for estimating a priori speech absence probability (SAP) of input speech data, the method comprising the steps of:
obtaining a local parameter and a global parameter by determining a smaller value than a first threshold value as 0, determining a greater value than a second threshold value as 1, and applying a sigmoid function to values between the first threshold value and the second threshold value;
obtaining an average parameter by a frame average of a posteriori signal-to-noise ratio in log scale; and
estimating the priori SAP using the local parameter, the global parameter and the average parameter.

2. The method of claim 1, wherein the local parameter and the global parameter are obtained by the following equation:
$${P}_{SNR} ( k , l ) = \{ \begin{matrix}0 , & if {ζ}_{SNR} ( k , l ) \leq {ζ}_{min} \\ 1 , & if {ζ}_{SNR} ( k , l ) \geq {ζ}_{max} \\ \frac{\{ 1 - cos ( π ( \frac{{ζ}_{SNR} ( k , l ) - {ζ}_{min}}{{ζ}_{max} - {ζ}_{min}} ) ) \}}{2} , & otherwise ,\end{matrix}$$
where
ζₘᵢₙ denotes the first threshold value,
ζₘₐₓ denotes the second threshold value, and
ζ_{SNR}(k,l) denotes a local or global average of the posteriori signal-to-noise ratio in log scale.

3. The method of claim 2, wherein the local or global average of the posteriori signal-to-noise ratio in log scale is obtained by the following equation:
$${ζ}_{SNR} ( k , l ) = {\sum }_{i = - ω}^{i = {ω}_{λ}} {h}_{SNR} ( i ) log\_SNR ( k - i , l ) ,$$
where log_SNR(k,l) denotes the posteriori signal-to-noise ratio in log scale.

4. The method of claim 1, wherein the average parameter is obtained by the following equations:
$$\begin{matrix}if {ζ}_{frame} ( l ) > {ζ}_{min} then & \\ If {ζ}_{frame} ( l ) > {ζ}_{frame} ( l - 1 ) then & \\ {P}_{frame} ( l ) = 1 & \\ {ζ}_{peak} ( l ) = min \{ max [ {ζ}_{frame} ( l ) , {ζ}_{p min} ] , {ζ}_{p min} \} & \\ else & \\ {P}_{frame} ( l ) = μ ( l ) & \\ else & \\ {P}_{frame} ( l ) = 0 & \\ , and & \\ μ ( l ) = \{ \begin{matrix}0 , & \begin{matrix}if {ζ}_{frame} ( l ) \leq \\ {ζ}_{peak} ( l ) + {ζ}_{min}\end{matrix} \\ 1 , & \begin{matrix}if {ζ}_{frame} ( l ) \geq \\ {ζ}_{peak} ( l ) + {ζ}_{max}\end{matrix} \\ \frac{1 - cos ( π ( \frac{\begin{matrix}{ζ}_{frame} ( l ) - \\ ( {ζ}_{peak} ( l ) + {ζ}_{min} )\end{matrix}}{{ζ}_{max} + {ζ}_{min}} ) )}{2} , & otherwise\end{matrix} & \end{matrix}$$
where ζ_{frame}(l) denotes the frame average of the posteriori signal-to-noise ratio in log scale.

5. The method of claim 4, wherein the frame average of the posteriori signal-to-noise ratio in log scale is obtained by the following equation:
$${ζ}_{frame} ( l ) = {mean}_{1 \leq k \leq N / 2 + 1} log\_SNR ( k , l ) ,$$
where log_SNR(k,l) denotes the posteriori signal-to-noise ratio in log scale.

6. The method of claim 3, wherein the posteriori signal-to-noise ratio in log scale is obtained by the following equation:
log_{—}SNR(k,l)=α_{SNR}log_{—}SNR(k,l−1)+(1−α_{SNR})(log_{—}y(k,l)−log_{—}d(k,l)),
where
log_y(k,l) denotes a log energy of an observed signal, and
log_d(k,l) denotes a log energy of a noisy signal.

7. The method of claim 6, wherein the log energy of the observed signal is calculated by the following equation:
log_{—}y(k,l)=α log_{—}y(k,l−1)+(1−α)log(|Y(k,l)|²).

8. The method of claim 7, wherein the log energy of the noisy signal is calculated by the following equation:
$$\begin{matrix}If log ( {\vert d ( k , l ) \vert}^{2} ) - log\_d ( k , l - 1 ) \leq SNR\_THRESHOLD \_UPDATE , then & \\ If log ( {\vert d ( k , l ) \vert}^{2} ) - log\_d ( k , l - 1 ) \leq 0 , then & \\ log\_d ( k , l ) = ( 1 - {β}_{low} ) log ( {\vert d ( k , l ) \vert}^{2} ) & \\ If log ( {\vert d ( k , l ) \vert}^{2} ) - log\_d ( k , l - 1 ) > 0 , then & \\ log\_d ( k , l ) = ( 1 - {β}_{high} ) log ( {\vert d ( k , l ) \vert}^{2} ) & \end{matrix}$$

9. The method of claim 1, wherein the priori SAP is estimated by a recursive scheme represented by the following equation:
q(k,l)=α_{q}q(k,l−1)+(1−α_{q})\tilde{q}(k,l),
where
q(k,l) denotes the priori SAP, and
\tilde{q}(k,l) denotes an instantaneous SAP.

10. The method of claim 9, wherein the local parameter, the global parameter and the average parameter define the instantaneous SAP according to the following equations:
$$p ( k , l ) = {P}_{local} ( k , l ) {P}_{global} ( k , l ) {P}_{frame} ( l )$$
$$\tilde{q} ( k , l ) = \frac{1}{1 + {e}^{- ɛ ( p ( k , l ) - 0.5 )}} .$$
where
P_{local}(k,l) denotes the local parameter,
P_{global}(k,l) denotes the global parameter, and
P_{frame}(l) denotes the average parameter.

11. A method for estimating a priori SAP, the method comprising the steps of:
obtaining a log energy of an observed signal;
obtaining a log energy of a noisy signal;
obtaining a posteriori signal-to-noise ratio in log scale using the log energy of the observed signal and the log energy of the noise signal;
obtaining local and global averages of the posteriori signal-to-noise ratio in log scale from the posteriori signal-to-noise ratio in log scale;
obtaining a local parameter and a global parameter by determining a threshold value for the local and global averages and applying a sigmoid function;
obtaining a frame average of the posteriori signal-to-noise ratio in log scale;
obtaining an average parameter using the frame average of the posteriori signal-to-noise ratio in log scale;
obtaining an instantaneous SAP using the local parameter, the global parameter and the average parameter; and
obtaining the priori SAP using the instantaneous SAP.

12. The method of claim 11, wherein the step of obtaining a log energy of an observed signal is performed by the following equation:
log_{—}y(k,l)=α log_{—}y(k,l−1)+(1−α)log(|Y(k,l)|²),
where log_y(k,l) denotes the log energy of the observed signal.

13. The method of claim 11, wherein the step of obtaining a log energy of a noisy signal is performed by the following equation:
$$\begin{matrix}If log ( {\vert d ( k , l ) \vert}^{2} ) - log\_d ( k , l - 1 ) \leq SNR\_THRESHOLD \_UPDATE , then \\ If log ( {\vert d ( k , l ) \vert}^{2} ) - log\_d ( k , l - 1 ) \leq 0 , then \\ log\_d ( k , l ) = ( 1 - {β}_{low} ) log ( {\vert d ( k , l ) \vert}^{2} ) \\ If log ( {\vert d ( k , l ) \vert}^{2} ) - log\_d ( k , l - 1 ) > 0 , then \\ log\_d ( k , l ) = ( 1 - {β}_{high} ) log ( {\vert d ( k , l ) \vert}^{2} )\end{matrix}$$
where log_d(k,l) denotes the log energy of the noisy signal.

14. The method of claim 11, wherein the step of obtaining a posteriori signal-to-noise ratio in log scale is performed by the following equation:
log_{—}SNR(k,l)=α_{SNR}log_{—}SNR(k,l−1)+(1−α_{SNR})(log_{—}y(k,l)−log_{—}d(k,l)),
where log_SNR(k,l) denotes the posteriori signal-to-noise ratio in log scale.

15. The method of claim 11, wherein the step of obtaining local and global averages of the posteriori signal-to-noise ratio in log scale is performed by the following equation:
$${ζ}_{SNR} ( k , l ) = {\sum }_{i = - ω}^{i = {ω}_{λ}} {h}_{SNR} ( i ) log\_SNR ( k - i , l ) ,$$
where ζ_{SNR}(k,l) denotes the local or global average of the posteriori signal-to-noise ratio in log scale.

16. The method of claim 11, wherein the step of obtaining a local parameter and a global parameter is performed by the following equation:
$${P}_{SNR} ( k , l ) = \{ \begin{matrix}0 , & if {ζ}_{SNR} ( k , l ) \leq {ζ}_{min} \\ 1 , & if {ζ}_{SNR} ( k , l ) \geq {ζ}_{max} \\ \frac{\{ 1 - cos ( π ( \frac{{ζ}_{SNR} ( k , l ) - {ζ}_{min}}{{ζ}_{max} - {ζ}_{min}} ) ) \}}{2} , & otherwise ,\end{matrix}$$
where P_{SNR}(k,l) denotes the local or global parameter.

17. The method of claim 11, wherein the step of obtaining a frame average of the posteriori signal-to-noise ratio in log scale is performed by the following equation:
$${ζ}_{frame} ( l ) = {mean}_{1 \leq k \leq N / 2 + 1} log\_SNR ( k , l ) ,$$
where ζ_{frame}(l) denotes the frame average of the posteriori signal-to-noise ratio in log scale.

18. The method of claim 11, wherein the step of obtaining an average parameter is performed by the following equations:
$$\begin{matrix}if {ζ}_{frame} ( l ) > {ζ}_{min} then & \\ If {ζ}_{frame} ( l ) > {ζ}_{frame} ( l - 1 ) then & \\ {P}_{frame} ( l ) = 1 & \\ {ζ}_{peak} ( l ) = min \{ max [ {ζ}_{frame} ( l ) , {ζ}_{p min} ] , {ζ}_{p min} \} & \\ else & \\ {P}_{frame} ( l ) = μ ( l ) & \\ else & \\ {P}_{frame} ( l ) = 0 & \\ , and & \\ μ ( l ) = \{ \begin{matrix}0 , & \begin{matrix} if {ζ}_{frame} ( l ) \geq \\ {ζ}_{peak} ( l ) + {ζ}_{min}\end{matrix} \\ 1 , & \begin{matrix}if {ζ}_{frame} ( l ) \geq \\ {ζ}_{peak} ( l ) + {ζ}_{max}\end{matrix} \\ \frac{1 - cos ( π ( \frac{\begin{matrix}{ζ}_{frame} ( l ) - \\ ( {ζ}_{peak} ( l ) + {ζ}_{min} )\end{matrix}}{{ζ}_{max} + {ζ}_{min}} ) )}{2} , & otherwise ,\end{matrix} & \end{matrix}$$
where P_{frame}(l) denotes the average parameter.

19. The method of claim 11, wherein the step of obtaining an instantaneous SAP is performed by the following equations:
$$p ( k , l ) = {P}_{local} ( k , l ) {P}_{global} ( k , l ) {P}_{frame} ( l )$$
$$\tilde{q} ( k , l ) = \frac{1}{1 + {e}^{- ɛ ( p ( k , l ) - 0.5 )}} ,$$
where
P_{local}(k,l) denotes the local parameter,
P_{global}(k,l) denotes the global parameter,
\tilde{q}(k,l) denotes the instantaneous SAP, and
ε denotes an increasing weight.

20. The method of claim 11, wherein the step of obtaining the priori SAP is performed by the following equation:
q(k,l)=α_{q}q(k,l−1)+(1−α_{q})\tilde{q}(k,l),
where q(k,l) denotes the priori SAP.
